(19) United States
(12) Patent Application Publication
(10) Pub. No.: US 2002/0111770 A1
(43) Pub. Date: Aug. 15, 2002

(54) System and method for visual analysis and evaluation of color scales on multiple computer output devices

(76) Inventors: Alan D. Kalvin, Irvington, NY (US); Bernice E. Rogowitz, Ossining, NY (US)

Correspondence Address: IBM CORPORATION, INTELLECTUAL PROPERTY LAW DEPT., P.O. BOX 218, YORKTOWN HEIGHTS, NY, 10598, US

(21) Appl. No.: 10/056,375

(22) Filed: Jan. 24, 2002

Related U.S. Application Data
(60) Provisional application No. 60/263,738, filed on Jan. 24, 2001.

(51) Int. Cl. G21C 17/00

(52) U.S. Cl. 702/183; 345/418

(57) ABSTRACT

A system and method for evaluating color scales (also called color tables, color maps, or color legends) is used in creating graphical representations of digital data, and where these graphical representations are presented for viewing on color output devices such as electronic computer displays, computer printers, etc. The problem of determining whether a particular viewing setup preserves the perceptual ordering of a given color scales as follows: The color scale is applied to a digital test pattern, and the resulting color-coded picture (also know as a “pseudo-colored” picture) is then viewed and rated by a human observer.

This disclosure claims priority and incorporates by reference in its entirety the U.S. provisional patent application Ser. No. 06/263,738 filed on Jan. 24, 2001 to A. Kalvin, entitled “System and method for visual analysis and evaluation of color scales in uncontrolled display.”

### FIELD OF THE INVENTION

This invention relates to the field of computer/human interfaces. More specifically, the invention relates to computer output devices such as electronic computer displays and computer printers, and in particular to a system and method for evaluating color scales that are used to produce graphical representations of digital data on such output devices.

### BACKGROUND OF THE INVENTION

Digital data, and in particular tabular data, can often be best understood and analyzed when presented to a human analyst in a graphical form such as a two-dimension digital image in which the data values are represented as color-coded picture elements (pixels). A typical example of such an image is a weather map in which temperature is colored according to a color scale (the color scale is usually referred to as a “color legend” in this context). Other examples include digital medical images produced by body scanners such as CT (Computed Tomography), MRI (Magnetic Resonance Imaging), PET (Positron Emission Tomography), SPECT (Single Photon Emission Computerized Tomography), and ultrasound.

In order to facilitate accurate visual analysis of such numerical data, it is important for designers of human/computer interfaces (HCI) to select color scales that represent the data faithfully, and do not obscure true features of the data or introduce perceptual artifacts. In general, the HCI designers' goal is to construct and use “perceptually ordered” color scales. A color scale is said to be “perceptually ordered” if positive increments in data values are perceived as positive steps in the color scale.

A serious problem faced in achieving this HCI goal is the fact that color rendition (and hence color perception) can vary significantly between color output device. The three major reasons for this are: (1) The variation in the physical and electrical characteristics of such output devices. This color variation occurs even among individual devices of the same type; (2) the variation in ambient lighting in the vicinity of the output color device; and (3) the variation in color vision among individuals (e.g. colorblind individuals perceive certain colors quite differently from individuals with normal color vision, and even within individuals having normal color vision, color perception is affected by the aging process). We shall from now on use the term “viewing setup” to refer to a specific combination of (1) color output device, (2) ambient lighting, and (3) human observer's color vision.

Problems with the Prior Art

From the above discussion it is apparent that a color scale that is perceptually uniform in one viewing setup may not necessarily be perceptually ordered in a second, different viewing setup. This poses the following serious problem for HCI designers: in designing and using perceptually ordered color scales, how can a designer distinguish between (a) viewing setups in which preserve the perceptually ordering of the color map and (b) viewing setups that do not. This problem is often further compounded by the fact that the designer may not know in which viewing setups the color scale will be used.

One possible prior art approach to this problem is to achieve uniform color rendition across devices and lighting conditions by the process of device characterization and calibration. Generally, there are two prior art methods for doing this.

In the first prior art method, measuring tools known as calorimeters, photometers, or spectroradiometers are used to measure the output from a device, and then a desired color rendition is provided by a “calibration process” in which modifications are made to one or both of the following: (a) the color rendering characteristics of the device, and (b) the input data to the device. However, these measuring tools are expensive and must themselves be calibrated. Furthermore, the calibration process typically does not lend itself to being performed by an ordinary end-user of the equipment, and usually requires the presence of a knowledgeable technician to make measurements. An additional problem occurs for “network devices” that are accessed remotely over a computer network, since they are not physical available for calibration. In addition, this prior art method does not address (let alone solve) the problem of individual variations in human in color vision.

In the second prior art method, the human visual system is used as the measuring tool. Typically a human operator is presented with a sequence of visual test patterns which the operator is required to manipulate and compare. The responses of the operator are used the construct a “profile” of the color rendering characteristics of the device. Unlike the first prior art method, this prior art method can deal with the problem of individual variations in human in color vision. However, like the first prior method it suffers from the limitation of being extremely time-consuming, and particularly for network-based viewers (such as Internet-based viewers), it is impractical, because of the prohibitive amount of time and effort required to construct the profile.

Objects of the Invention

An object of this invention is to provide a device-free system and method for insuring reliable color representations on color output devices.

An object of this invention is to provide a device-free system and method for insuring reliable color representations on computer user interfaces.

An object of this invention is to provide a device-free system and method for insuring reliable color representations on computer user interfaces in networking applications.

### SUMMARY OF THE INVENTION

This invention solves the problem of determining whether a particular viewing setup preserves the perceptual ordering of a given color scales as follows: The color scale is applied to a digital test pattern, and the resulting color-coded picture (also know as a “pseudo-colored” picture) is then viewed and rated by a human observer.

In the preferred embodiment of this invention, the test pattern consists of a monochromatic (or “gray-scale”) digital photograph of a human face. The invention exploits the fact that the human visual system is high-tuned for the detection and identification of human faces. From now on, we shall describe the invention in terms of this preferred embodiment, although it is clear that other embodiments (using other types of test patterns) of this invention are also possible.

### BRIEF DESCRIPTION OF THE FIGURES

The foregoing and other objects, aspects, and advantages will be better understood from the following non-limiting detailed description of preferred embodiments of the invention with reference to the drawings that include the following:

FIG. 1 is a block diagram of one preferred embodiment of the present system.

FIG. 2 is diagram of plurality of color scales applied to a single test pattern, as used by one or more clients to evaluate each of these color scales as to its suitability for the respective client's viewing setup.

FIG. 3 is a flow chart of the process of creating and rating the pictures produced by applying each color scale to the test pattern.

FIG. 4 is a block diagram of the process used for rating the color-coded pictures that are produced through the application of the color scales to the test pattern.

FIG. 5 is flow chart of the process of evaluating perceptual uniformity of the color scales.

### DETAILED DESCRIPTION OF THE INVENTION

In a preferred embodiment of the invention, the user is presented with a collection of candidate color scales. This collection is designed to contain a set of color scales that cover a wide variety of different viewing setups. For each color scale in the collection, the viewer is presented with the corresponding colored-coded photograph of a human face. Thus a viewer can quickly evaluate the color scales within the context of his/her specific viewing environment.

Among the advantages of our invention is that is it fast, inexpensive, and easy to use. Furthermore, this invention is specifically designed to solve the problem of evaluating color scales for the property of being perceptually ordered, rather than attempting to solve the broader problem of ensuring color fidelity across multiple color output devices. In practice, a color scale almost always contains a small subset of all possible colors that a color output device can produce. Therefore this method provides more accurate results than prior art methods, since by design these methods need to find solutions that accommodate all colors in the gamut of the output device.

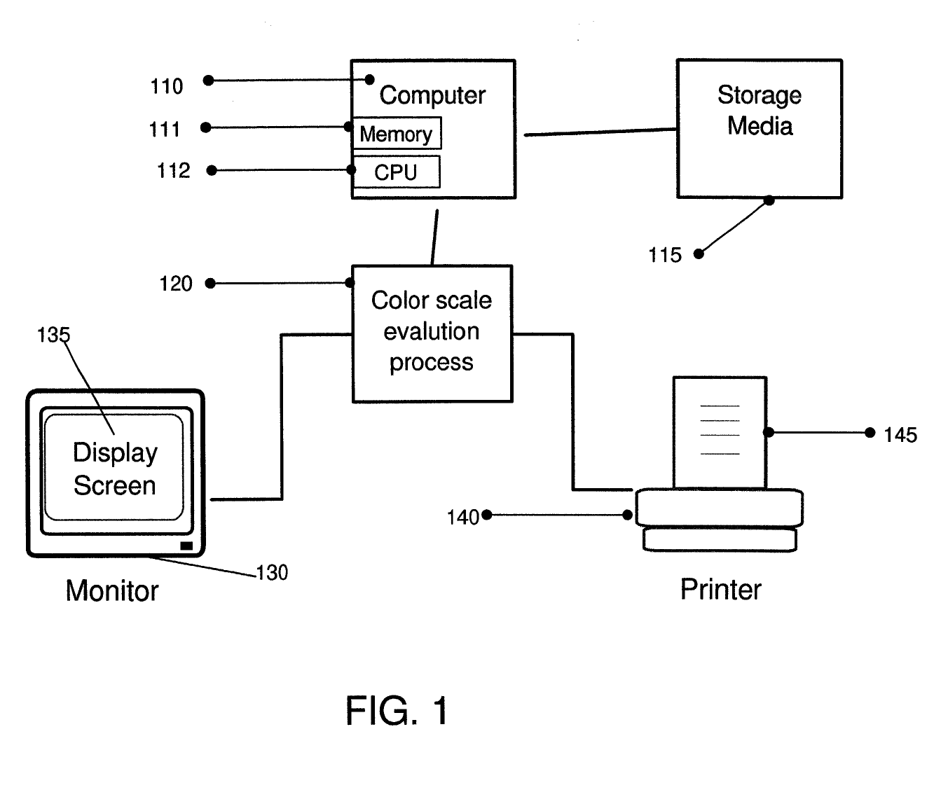

Referring now to the drawings, and more particularly to FIG. 1, there is shown a schematic view of one preferred embodiment of the invention. A computer 110, having a memory 111, and CPU (central processing unit) 112, and attached to one or more storage media 115 executes the color scale evaluation process 120, through the output of a set of color-coded pictures on an output color device such as the display screen 135 of an electronic monitor 130, and on a page of paper 145 printed by a color printer 140. Other color input/output devices (130, 140) are envisioned.

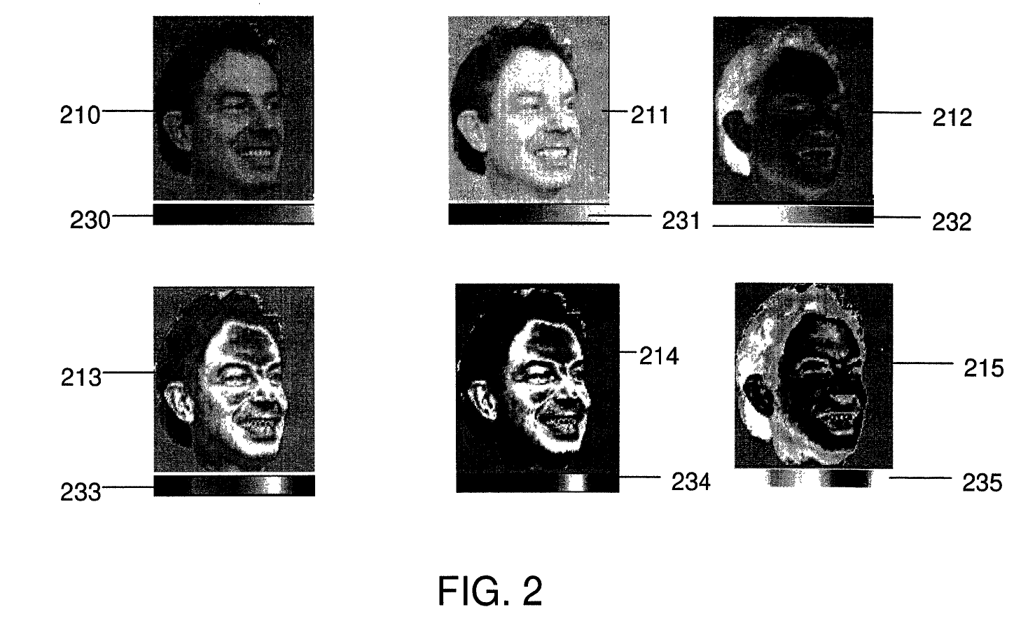

FIG. 2 illustrates the concept of applying a plurality of color scales to a test pattern of a human face. In FIG. 2 are six examples of color-coded pictures 210, 211, 212, 213, 214, 215 of a human face. These six color-coded pictures were produced by applying to them the color scales 230, 231, 232, 233, 234, 235, respectively. (Note that since (a) many chromatic color scales do not reproduce well in monochrome, and (b) this document has been prepared for monochrome reproduction, for convenience, all the color scales 230, 231, 232, 233, 234, 235 shown in FIG. 2, a non-limiting preferred embodiment, are monochromatic color scales.)

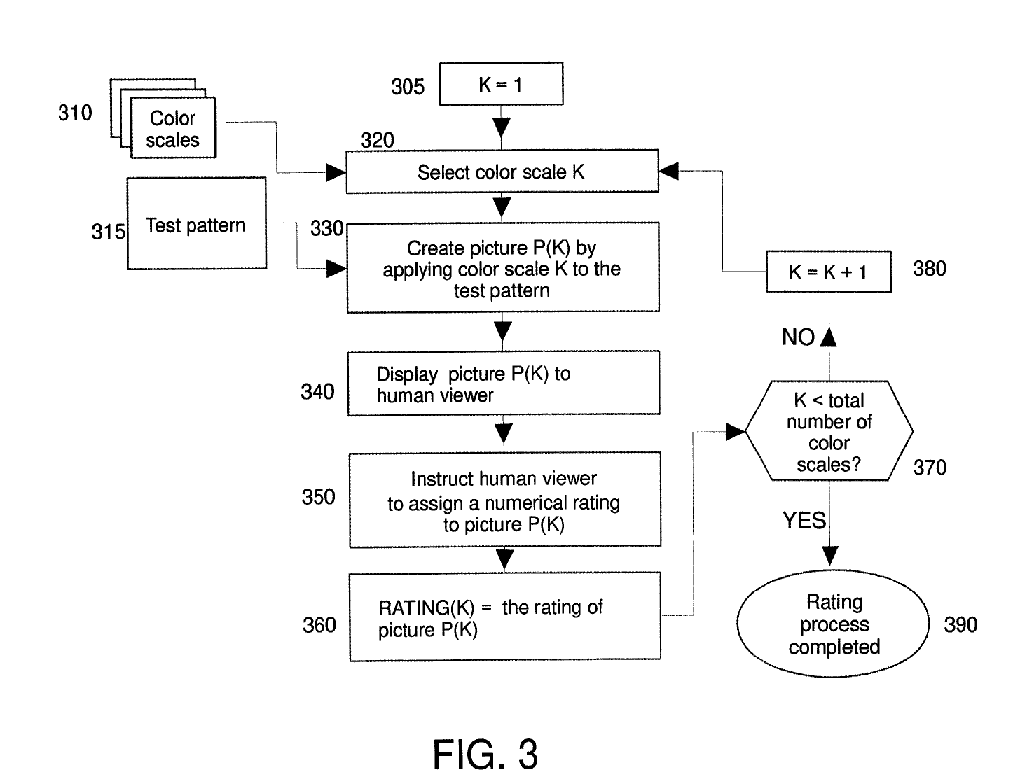

FIG. 3 shows a flow chart of the process of creating and rating of the pictures that are produced by applying each color scale to the test pattern. In block 305 a counter K is set to 1. In block 320 color scale number K is selected from the set of color scales 310 that are being evaluated. In block 330, color scale number K is applied to the test pattern 315, to produce the color-coded picture P(K). In block 340, picture P(K) is displayed to the human viewer on a color output device. In block 350 the computer system instructs the human viewer to rate the perceived “normalness” of the colored face in picture P(K). The instructions to the viewer define a “normal” picture to be one that is perceived to look (i) exactly like a “black and white photograph” or (ii) exactly like a tinted “black and white photograph”. In a preferred embodiment, the rating is made on a scale of five values as follows: 2 means “completely normal”, 1 means “reasonably normal”, 0 means “undecided”, −1 means “somewhat abnormal”, and −2 means “extremely abnormal”. The rating value assigned to picture P(K) is stored for later processing in block 360. In block 370, the value of K compared with the total number of color scales to determine whether all the color scales have been processed. If K is less than the total number of color scales, K is incremented by one in block 380, and the process loop consisting of blocks 320, 330, 340, 350, 360 is repeated. On the other hand, if K is equal to the total number of color scales, the rating process is complete, and terminates (termination block 390).

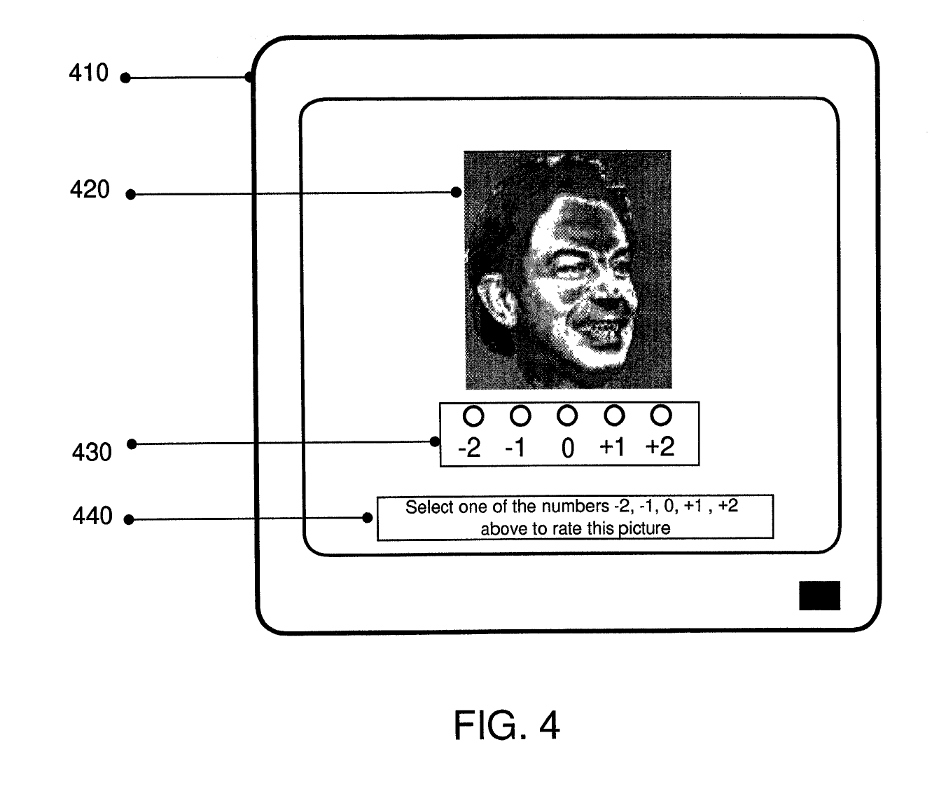

FIG. 4 is a schematic diagram showing in more detail the process of ranking a color-coded picture (i.e. blocks 340-350 of FIG. 3). In FIG. 4, the color output device 410 displays a color-coded picture 420 together with a rating scale 430 and instructions 440 for rating the picture 420. The human viewer visually inspects the picture 420, and then rates its “normalness” by selecting the appropriate value on the rating scale 430. This rating scale is based on the following observations. A perceptually ordered color scale will produce a picture of human face in which the color variations correspond precisely to the shadows, highlights and other lighting variations of a normally illuminated human face. On the other hand, a color scale that is not perceptually ordered with produce a picture of an abnormal looking face, since the relative brightness of the different parts of the face will deviate from a normally illuminated face. Furthermore, the more the color scale violates the condition of perceptual ordering, the more anomalous the resulting color-coded face will appear to be.

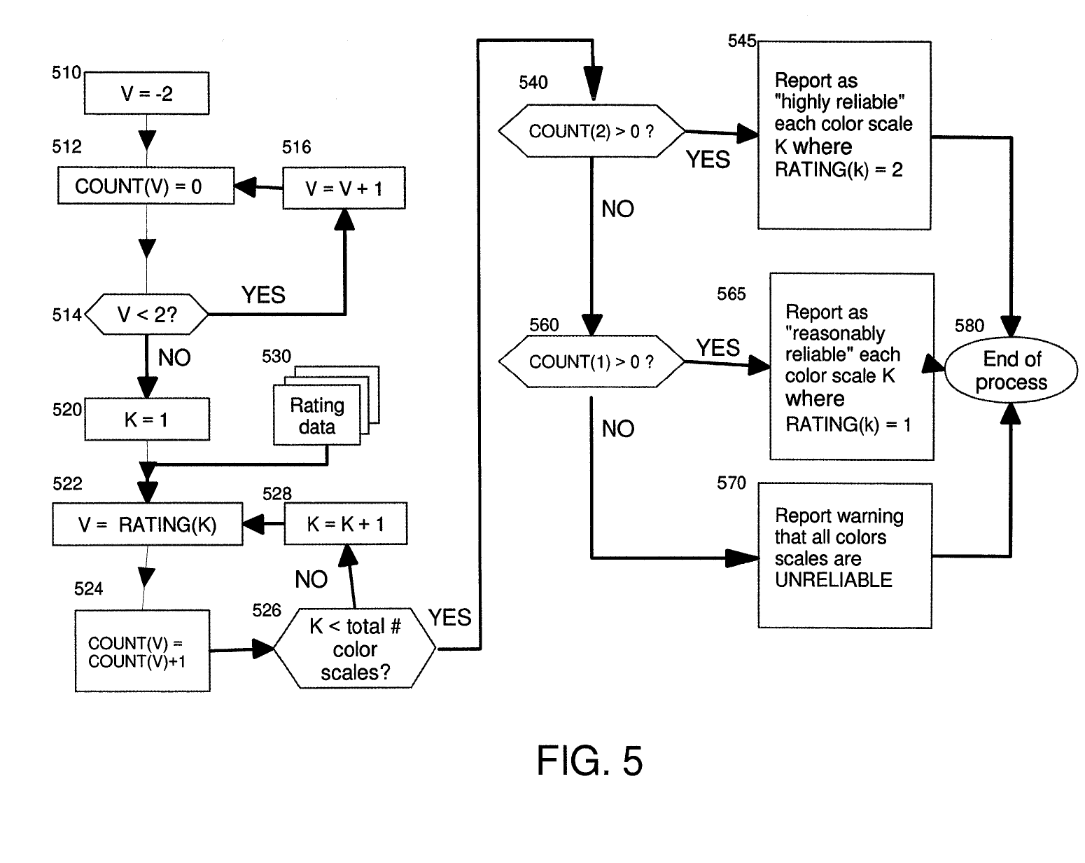

FIG. 5 if a flowchart of the process of evaluating the set of color scales from the ratings of color-coded pictures. Process blocks 510, 512, 514, and 516 show the process of setting to zero the values of the five counters used to count the number of pictures in each of the rating groups −2, −1, 0, 1, and 2. Process blocks 520, 522, 524, 526, and 528 show the process of counting up the number of pictures in each of the rating groups −2, −1, 0, 1, and 2, using the previously stored picture rating data 530. After this counting process is finished, and the YES output path from block 526 is selected, test block 540 is evaluated to check if there are any pictures with a rating of 2. If there are, block 545 is executed, reporting that the corresponding color scales (i.e. those used to produce the pictures with rating 2) are “highly reliable” for use as perceptually ordered color scales within the current viewing setup, and the process is complete (termination block 580).

On the other hand, if the are no pictures with a rating of 2 (test block 540 evaluates to NO), test block 560 is evaluated to check if there are any pictures with a rating of 1. If there are, block 565 is executed, reporting that the corresponding color scales (i.e. those used to produce the pictures with rating 1) are “reasonably reliable” for use as perceptually ordered color scales within the current viewing setup, and the process is complete (termination block 580).

On the other hand, if the are no pictures with a rating of 1 (test block 560 evaluates to NO), process block 570 is executed, warning that all of the color scales have been evaluated as “unreliable” for use as perceptually ordered color scales within the current viewing setup, and the process is complete (termination block 580).

We claim the following:

1. A system for evaluating one or more color scales comprising:
an input interface that receives one or more color scales, and one or more test patterns;
one or more color output devices; and
an evaluation process that applies the color scales to the test pattern to determine which of the color scales can be used to create color-coded images on the color output device without violating the condition of perceptual ordering by more than a tolerance.

2. A system, as in claim 1, where the evaluation process warns the user when a color scale can not be used to create color-coded images on the color output device without violating the condition of perceptual ordering by more than a tolerance.

3. A system, as in claim 1, further comprising a rating process used to evaluate the colors scales as determined by a perceptual ordering of the test pattern by the user where the respective color scale is used to render the test pattern to the user.

4. A system, as in claim 1, where the color output device includes any one or more of the following: a user computer interface, a graphical user interface, an electronic color display, a color printer, a television monitor, and a medical equipment interface

5. A system, as in claim 1, where one or more color reproduction characteristics of the color output device are unknown.

6. A system, as in claim 1, where an ambient illumination environment of the color output device is unknown.

7. A system, as in claim 1, where a quality of the user's color vision is unknown.

8. A method for evaluating one or more color scales comprising the steps of:
receiving one or more color scales, and one or more test patterns; and
applying the color scales to the test pattern to determine which of the color scales can be used to create color-coded images on the color output device without violating the condition of perceptual ordering by more than a tolerance.

9. A computer program product having a stored computer program comprising the steps of:
receiving one or more color scales, and one or more test patterns; and
applying the color scales to the test pattern to determine which of the color scales can be used to create color-coded images on the color output device without violating the condition of perceptual ordering by more than a tolerance.

10. A system for evaluating one or more color scales comprising:
means for receiving one or more color scales, and one or more test patterns; and
means for applying the color scales to the test pattern to determine which of the color scales can be used to create color-coded images on the color output device without violating the condition of perceptual ordering by more than a tolerance.
